(19) United States
(12) Patent Application Publication
(10) Pub. No.: US 2026/0073900 A1
(43) Pub. Date: Mar. 12, 2026

(54) DOUBLE COIL GUITAR PICKUP ASSEMBLY

(71) Applicant: Omar Jana, MIAMI GARDENS, FL (US)

(72) Inventor: Omar Jana, MIAMI GARDENS, FL (US)

(21) Appl. No.: 18/826,459

(22) Filed: Sep. 6, 2024

(51) Int. Cl. G10H 3/18

(52) U.S. Cl. CPC G10H 3/181; G10H 2220/515

(57) ABSTRACT

A double coil guitar pickup assembly includes a first and a second bobbin, wherein each bobbin includes a center section with a hollow interior, a coil wrapped around the center section, a top flange with a diameter greater than a diameter of the center section, and a bottom flange, wherein the top flange has a lateral-facing protrusion and adjacent depression, wherein the first and second bobbins are coupled such that the protrusion of the first bobbin fits securely within the depression of the second bobbin, and such that the protrusion of the second bobbin fits securely within the depression of the first bobbin, and, a cover configured to fit securely over the first and second bobbins, including a pair of fastening orifices configured for fastening the cover to a guitar.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of musical instruments and, more specifically, relates to the field of transducers or pickups for guitars.

### BACKGROUND

A pickup is a transducer that captures or senses mechanical vibrations produced by musical instruments, particularly stringed instruments such as the electric guitar, and converts these to an electrical signal that is amplified using an instrument amplifier to produce musical sounds through a loudspeaker. Single coil pickups have been favored for their bright, crisp sound that captures the nuances of a guitarist's playing. However, they are inherently prone to electromagnetic interference, which results in unwanted noise and hum, especially in environments with a high degree of electrical noise. This limitation can detract from the overall sound quality and performance, particularly in live settings or during recording sessions where clarity and purity of tone are paramount.

Double coil pickups, commonly referred to as humbuckers, were developed to mitigate the noise issues associated with single coil pickups. By using two coils with reverse polarity and wiring them in series, humbuckers effectively cancel out electromagnetic interference, providing a much cleaner and noise-free signal. This innovation significantly improved the reliability and sound quality of electric guitars equipped with humbuckers, making them a popular choice for many musicians seeking a robust and noise-free performance.

Despite their advantages in noise reduction, traditional double coil pickups come with their own set of drawbacks. One of the primary issues is their size. The bulkier design of double coil pickups requires more space within the guitar body, making them unsuitable for many guitars designed to house only the slimmer single coil pickups. This incompatibility limits the versatility of double coil pickups and restricts their use to certain guitar models. Additionally, the increased size and weight of double coil pickups can affect the balance and ergonomics of the instrument, potentially altering the playing experience and comfort for the guitarist.

Furthermore, the installation and maintenance of double coil pickups are more complex compared to their single coil counterparts. The larger size of the pickups necessitates more extensive modifications to the guitar body, which can be time-consuming and costly. The intricate wiring involved in connecting the two coils adds another layer of complexity, making it more challenging for guitarists to perform their own installations or repairs. These factors contribute to a higher barrier to entry for musicians who might otherwise benefit from the noise-canceling properties of humbuckers.

Moreover, the aesthetic appeal of the guitar can also be a consideration. The larger footprint of double coil pickups can disrupt the sleek, classic look of guitars designed with single coil pickups in mind, potentially detracting from the instrument's visual appeal. This visual and structural incompatibility further limits the adoption of double coil pickups in certain guitar models.

Therefore, a need exists to overcome the problems with the prior art as discussed above, and particularly for more efficient and improved double coil pickups for guitars.

### SUMMARY

A double coil guitar pickup assembly that addresses the problems with the prior art, is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a double coil guitar pickup assembly is provided that solves the above-described problems. The double coil guitar pickup assembly includes a first bobbin comprising a center section with a hollow interior, a top flange with a diameter greater than a diameter of the center section, and a bottom flange, wherein the top flange has a lateral-facing protrusion and adjacent depression, a first coil wrapped around the center section of the first bobbin, a second bobbin comprising a center section with a hollow interior, a top flange with a diameter greater than a diameter of the center section, and a bottom flange, wherein the top flange has a lateral-facing protrusion and adjacent depression, a second coil wrapped around the center section of the second bobbin, wherein the first bobbin is coupled with the second bobbin such that the protrusion of the first bobbin fits securely within the depression of the second bobbin, and such that the protrusion of the second bobbin fits securely within the depression of the first bobbin, and a cover configured to fit securely over the first and second bobbins, including a pair of fastening orifices configured for fastening the cover to a guitar.

### BRIEF DESCRIPTION OF THE DRAWINGS

The accompanying drawings, which are incorporated in and constitute a part of this disclosure, illustrate various example embodiments. In the drawings:

FIG. 1A depicts a front view of a first bobbin of a double coil guitar pickup assembly, according to an example embodiment.

FIG. 1B depicts a top view of the first bobbin of the double coil guitar pickup assembly, according to an example embodiment.

FIG. 1C depicts a bottom view of the first bobbin of the double coil guitar pickup assembly, according to an example embodiment.

FIG. 1D depicts a top perspective view of the first bobbin of the double coil guitar pickup assembly, according to an example embodiment.

FIG. 1E depicts a bottom perspective view of the first bobbin of the double coil guitar pickup assembly, according to an example embodiment.

FIG. 1F depicts a side view of the first bobbin of the double coil guitar pickup assembly, according to an example embodiment.

FIG. 2A depicts a front view of a second bobbin of the double coil guitar pickup assembly, according to an example embodiment.

FIG. 2B depicts a top view of the second bobbin of the double coil guitar pickup assembly, according to an example embodiment.

FIG. 2C depicts a bottom view of the second bobbin of the double coil guitar pickup assembly, according to an example embodiment.

FIG. 2D depicts a top perspective view of the second bobbin of the double coil guitar pickup assembly, according to an example embodiment.

FIG. 2E depicts a bottom perspective view of the second bobbin of the double coil guitar pickup assembly, according to an example embodiment.

FIG. 2F depicts a side view of the second bobbin of the double coil guitar pickup assembly, according to an example embodiment.

FIG. 3A depicts a top view of the first and second bobbins of the double coil guitar pickup assembly, according to an example embodiment.

FIG. 3B depicts a bottom view of the first and second bobbins of the double coil guitar pickup assembly, according to an example embodiment.

FIG. 3C depicts a top view of a joinder of the first and second bobbins of the double coil guitar pickup assembly, according to an example embodiment.

FIG. 3D depicts a side cross-sectional view of the first and second bobbins of the double coil guitar pickup assembly, according to an example embodiment

FIG. 4A depicts a top perspective view of a first cover of the double coil guitar pickup assembly, according to an example embodiment.

FIG. 4B depicts a bottom perspective view of the first cover of the double coil guitar pickup assembly, according to an example embodiment.

FIG. 4C depicts a front view of the first cover of the double coil guitar pickup assembly, according to an example embodiment.

FIG. 4D depicts a top view of the first cover of the double coil guitar pickup assembly, according to an example embodiment.

FIG. 4E depicts a side view of the first cover of the double coil guitar pickup assembly, according to an example embodiment.

FIG. 5A depicts a top perspective view of a second cover of the double coil guitar pickup assembly, according to an example embodiment.

FIG. 5B depicts a bottom perspective view of the second cover of the double coil guitar pickup assembly, according to an example embodiment.

FIG. 5C depicts a front view of the second cover of the double coil guitar pickup assembly, according to an example embodiment.

FIG. 5D depicts a top view of the second cover of the double coil guitar pickup assembly, according to an example embodiment.

FIG. 5E depicts a side view of the second cover of the double coil guitar pickup assembly, according to an example embodiment.

FIG. 6A depicts a top perspective view of a third cover of the double coil guitar pickup assembly, according to an example embodiment.

FIG. 6B depicts a bottom perspective view of the third cover of the double coil guitar pickup assembly, according to an example embodiment.

FIG. 6C depicts a front view of the third cover of the double coil guitar pickup assembly, according to an example embodiment.

FIG. 6D depicts a top view of the third cover of the double coil guitar pickup assembly, according to an example embodiment.

FIG. 7A depicts a top view of a printed circuit board of the double coil guitar pickup assembly, according to an example embodiment.

FIG. 7B depicts a depicts a bottom view of a printed circuit board of the double coil guitar pickup assembly, according to an example embodiment.

### DETAILED DESCRIPTION

The following detailed description refers to the accompanying drawings. Wherever possible, the same reference numbers are used in the drawings and the following description to refer to the same or similar elements. While embodiments of the claimed subject matter may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a double coil pickup that offer significant improvements in noise reduction and sound quality, while also providing a smaller size, lower weight, and less complexity. The claimed subject matter combines the noise-canceling benefits of double coil pickups with the compact, easy-to-install nature of single coil pickups, addressing the shortcomings of the prior art and expanding the versatility and appeal of guitar pickups for a broader range of instruments and musicians.

One of the most notable advantages of the claimed subject matter is the reduction in size and profile, allowing the double coil configuration to fit into the space typically reserved for single coil pickups. This expands the versatility of double coil pickups, making them compatible with a wider range of guitar models without requiring extensive modifications. The claimed subject matter provides the benefits of noise reduction and enhanced sound quality without sacrificing the aesthetic or structural integrity of their instruments.

Another key improvement of the claimed subject matter is the ease of installation and maintenance. The friction fit mechanism simplifies the assembly process, eliminating the need for screws, adhesives, or other fastening methods that can complicate installation and make disassembly more difficult. This user-friendly approach not only saves time and effort but also allows musicians to perform their own pickup upgrades or repairs with minimal technical expertise. The streamlined design ensures that the pickup remains securely in place during use while still being easily removable when needed.

Furthermore, the claimed subject matter enhances the durability and reliability of the pickup. The use of high-strength, lightweight materials for the body components ensures that the pickup can withstand the physical demands of regular playing and transportation. The protective coating or encasement around the coils provides additional shielding against electromagnetic interference, further reducing the risk of noise and hum. This combination of robust construction and effective noise cancellation results in a more dependable and consistent performance, which is crucial for both live performances and studio recordings.

In addition to these practical benefits, the claimed subject matter also offers tonal advantages. By incorporating high-quality materials and precise manufacturing techniques, the pickup delivers a clear, articulate sound with improved harmonic response. The ability to choose different types of magnets, such as alnico or ceramic, allows for further customization of the tonal characteristics, catering to the specific preferences and playing styles of individual guitarists.

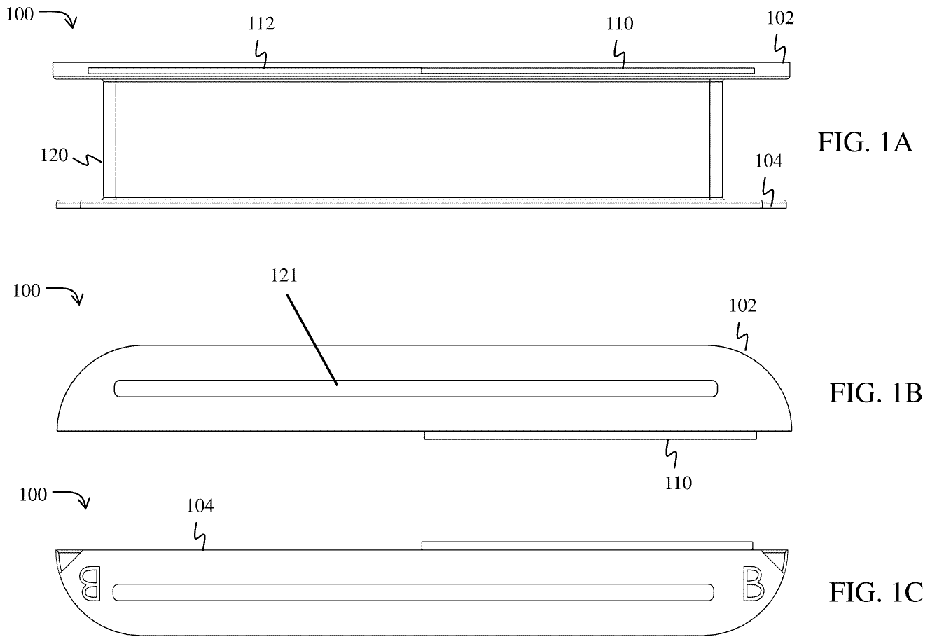

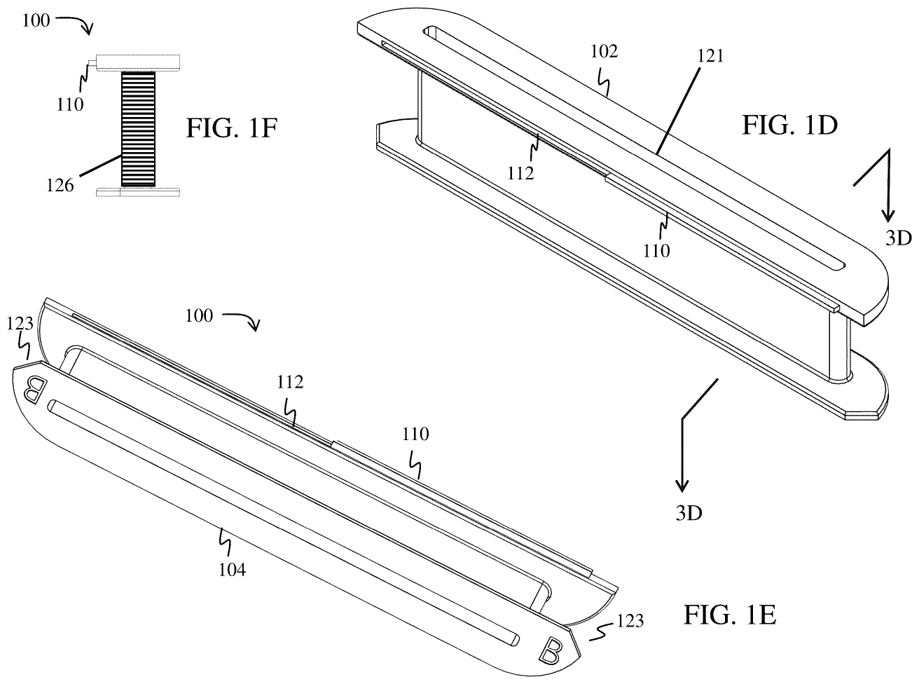

The accompanying drawings, which are incorporated in and constitute a part of this disclosure, illustrate various example embodiments. The claimed double coil guitar pickup assembly will now be described with respect to FIGS. 1A through 6E.

FIGS. 1A-1F depict various views of first bobbin 100 of a double coil guitar pickup assembly, according to an example embodiment. FIGS. 1A-1F show that the first bobbin 100 has a center section 120, which may have a substantially cuboid shape, with a hollow interior, wherein the center section has void 121 at its core. The first bobbin 100 also has a top flange 102, which may have a substantially half-oval shape. The top flange has a diameter greater than the diameter of the center section, such that the width and length of the top flange extends past the width and length of the center section. The first bobbin 100 also has a bottom flange 104, which may have a substantially half-oval shape. The bottom flange has a diameter greater than the diameter of the center section, such that the width and length of the bottom flange extends past the width and length of the center section. Also, the bottom flange may have truncated corners 123. Note also that the top flange may have a depth that is greater than the depth of the bottom flange.

FIGS. 1A-1F show that the first bobbin 100 has a lateral-facing protrusion 110, which may have a substantially cuboid shape, located on a later-facing side of the top flange 102. Adjacent to the protrusion may be a depression 112 which may have a substantially cuboid shape. The shape of the depression may match the shape of the protrusion. FIG. 1F shows that the center section 120 of the first bobbin 100 has been wrapped in a conductive coil 126. An electrically conductive wire is connected to a first terminal extending from the bobbin and is subsequently wound around the perimeter of the center section a predetermined number of times, such as 2500, 4000, 5000, or more, to create a first coil 126.

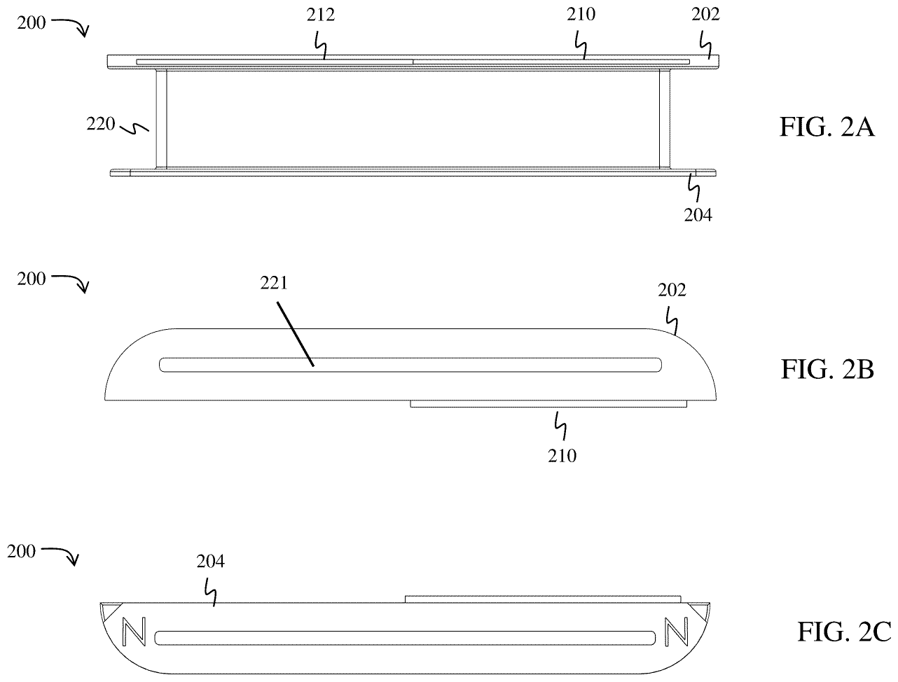

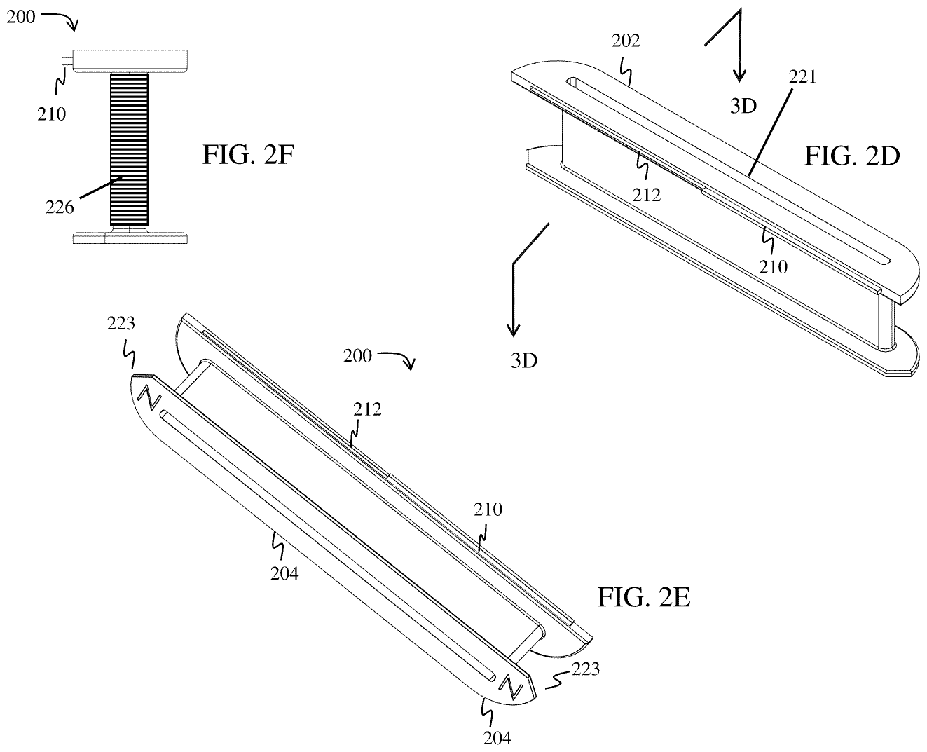

FIGS. 2A-2F depict various views of a second bobbin 200 of a double coil guitar pickup assembly, according to an example embodiment. FIGS. 2A-2F show that the second bobbin 200 has a center section 220, which may have a substantially cuboid shape, with a hollow interior, wherein the center section has void 221 at its core. The second bobbin 200 also has a top flange 202, which may have a substantially half-oval shape. The top flange has a diameter greater than the diameter of the center section, such that the width and length of the top flange extends past the width and length of the center section. The second bobbin 200 also has a bottom flange 204, which may have a substantially half-oval shape. The bottom flange has a diameter greater than the diameter of the center section, such that the width and length of the bottom flange extends past the width and length of the center section. Also, the bottom flange may have truncated corners 223. Note also that the top flange may have a depth that is greater than the depth of the bottom flange.

FIGS. 2A-2F show that the second bobbin 200 has a lateral-facing protrusion 210, which may have a substantially cuboid shape, located on a later-facing side of the top flange 202. Adjacent to the protrusion may be a depression 212 which may have a substantially cuboid shape. The shape of the depression may match the shape of the protrusion. FIG. 2F shows that the center section 120 of the second bobbin 200 has been wrapped in a conductive coil 226. An electrically conductive wire is connected to a first terminal extending from the bobbin and is subsequently wound around the perimeter of the center section a predetermined number of times, such as 2500, 4000, 5000, or more, to create a second coil 226.

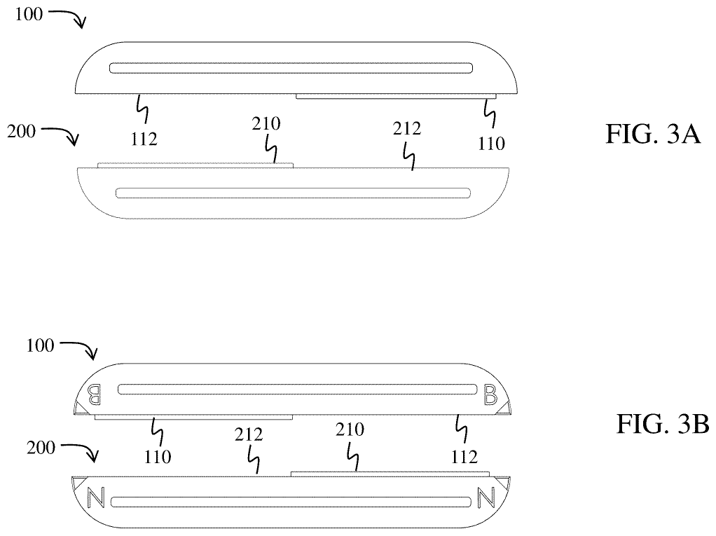

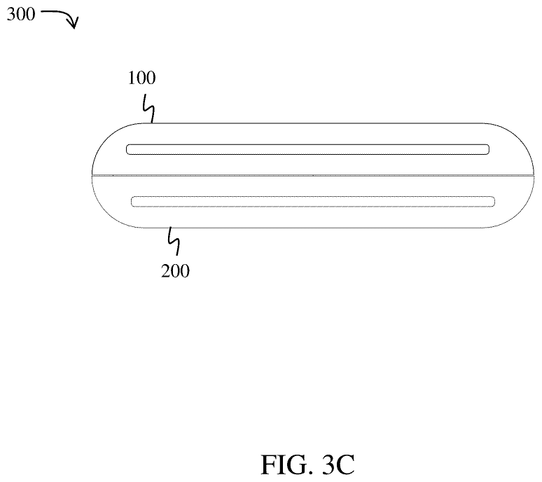

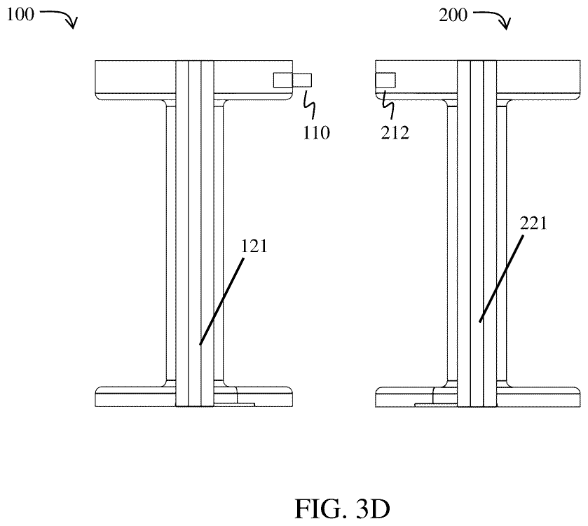

FIGS. 3A-3D depict various views of the first and second bobbins 100, 200 of the double coil guitar pickup assembly, according to an example embodiment. FIGS. 3A-3D show how it is that when the first and second bobbins 100, 200 are coupled, the protrusion 110 of the first bobbin fits securely within the depression 212 of the second bobbin, and the protrusion 210 of the second bobbin fits securely within the depression 112 of the first bobbin. the protrusions and the depressions are shaped and sized such that the protrusions fit securely within the depression when the two bobbins are joined. A friction fit, or interference fit, is a fastening between two parts which is achieved by friction after the parts are pushed together, rather than by any other means of fastening. A friction fit is achieved by shaping the two mating parts so that one or the other, or both, slightly deviate in size from the nominal dimension. One part slightly interferes with the space that the other occupies. The result is that both parts elastically deform slightly to fit together creating an extremely high force which results in extremely high friction between the parts.

FIG. 3C shows the joinder 300 of the first and second bobbins 100, 200 of the double coil guitar pickup assembly 300. FIG. 3C shows that when the two bobbins are joined, the top flange 102 and the top flange 202 (which individually have a substantially half-oval shape), form a full oval shape, which is the same profile as a single coil guitar pickup. In one embodiment, the first and second coils are arranged to be magnetically and electrically independent. In another embodiment, the first and second coils are coiled in opposite directions when placed as shown in FIG. 3C, such that the resulting magnetically fields point in opposite directions.

The cross-sectional view of FIG. 3D shows how the top flange of both bobbins has a diameter greater than the diameter of the center section, such that the width and length of the top flange extends past the width and length of the center section. Also, the bottom flange has a diameter greater than the diameter of the center section, such that the width and length of the bottom flange extends past the width and length of the center section. FIG. 3D also shows how the protrusion 110 of the first bobbin 100 fits securely within the depression 212 of the second bobbin 200.

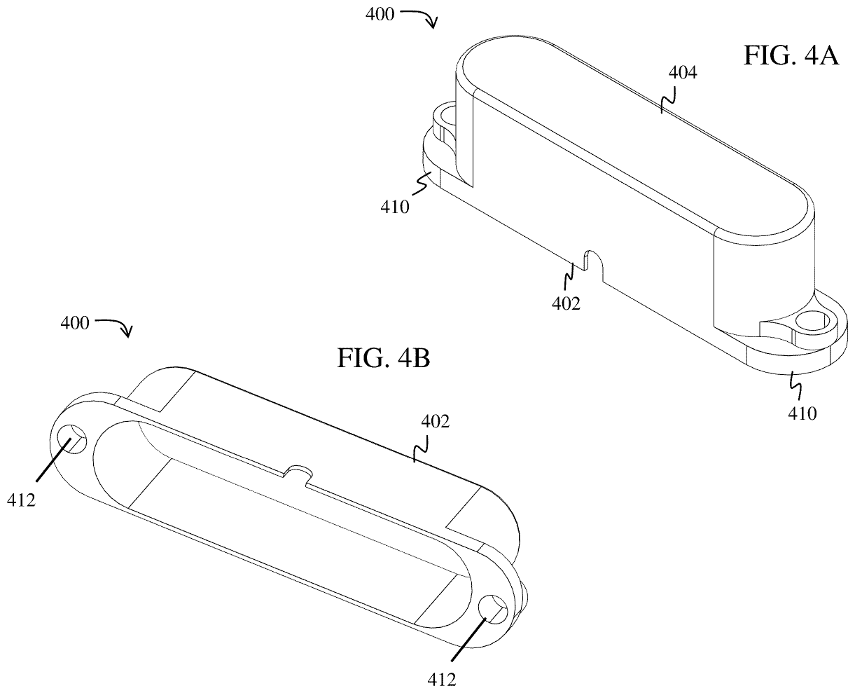

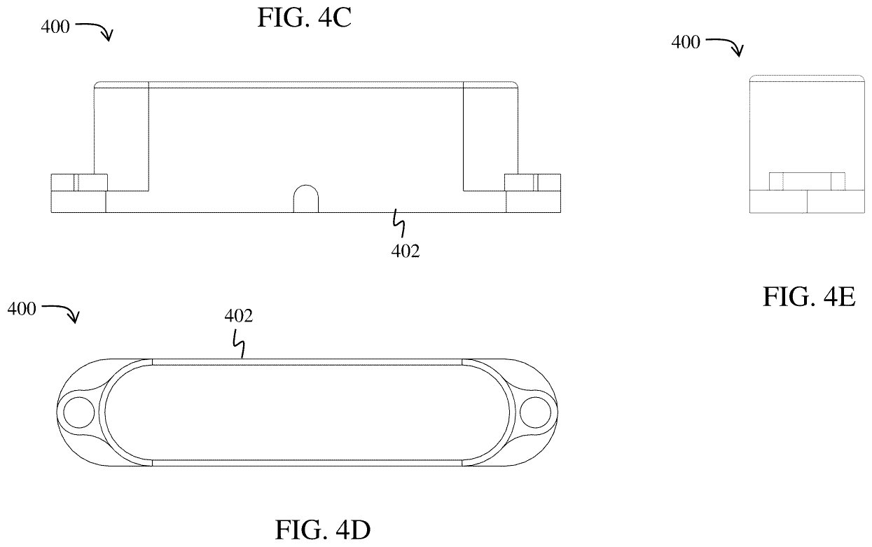

FIGS. 4A-4E depict various views of a first cover 400 of the double coil guitar pickup assembly, according to an example embodiment. FIGS. 4A-4E show how the first cover 400 includes a body 402 that is configured (i.e., shaped and sized) to be securely placed over the joinder 300 of the first and second bobbins 100, 200 double coil guitar pickup assembly 300. The top 404 of the body 402 completely covers an entirety of a top of the joinder 300 of the first and second bobbins 100, 200. The cover 400 includes a pair of flanges 410 on either end of the cover, within which are respectively located a pair of fastening orifices 412 configured for fastening the cover 400 to a guitar.

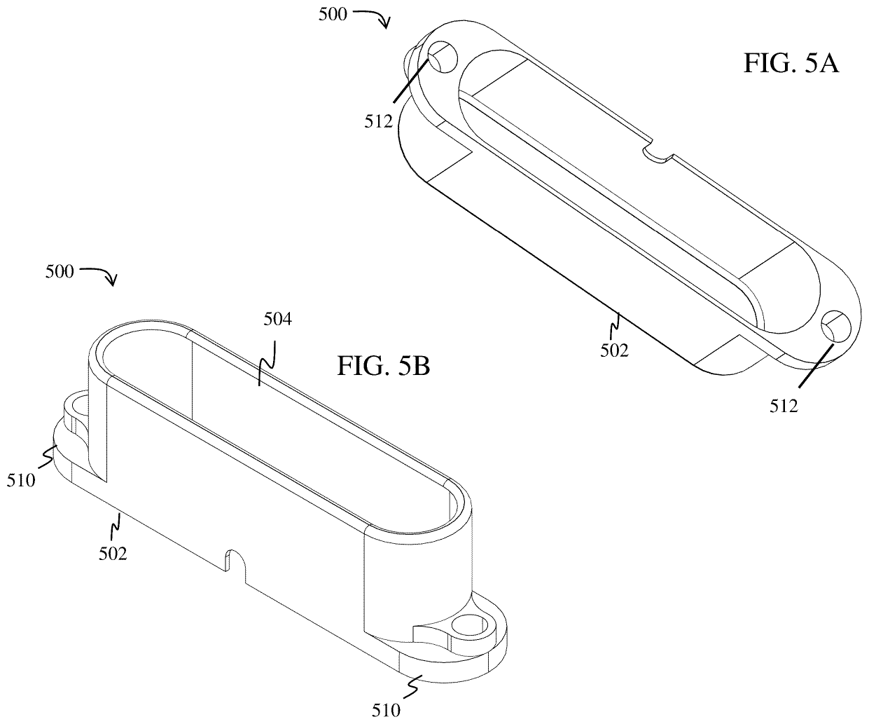

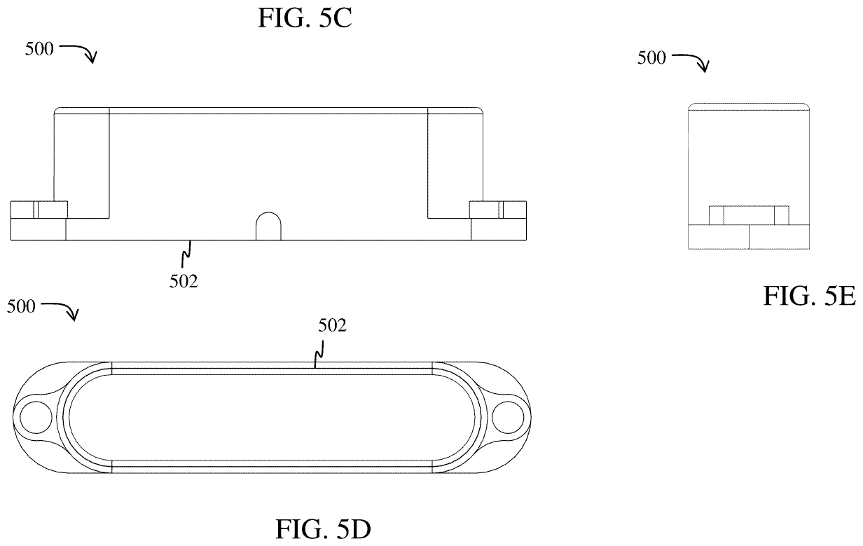

FIGS. 5A-5E depict various views of a second cover 500 of the double coil guitar pickup assembly, according to an example embodiment. FIGS. 5A-5E show how the second cover 500 includes a body 502 that is configured (i.e., shaped and sized) to be securely placed over the joinder 300 of the first and second bobbins 100, 200 double coil guitar pickup assembly 300. The top 504 of the body 502 is completely open so as to provide access to an entirety of a top of the joinder 300 of the first and second bobbins 100, 200. The cover 500 includes a pair of flanges 510 on either end of the cover, within which are respectively located a pair of fastening orifices 512 configured for fastening the cover 500 to a guitar.

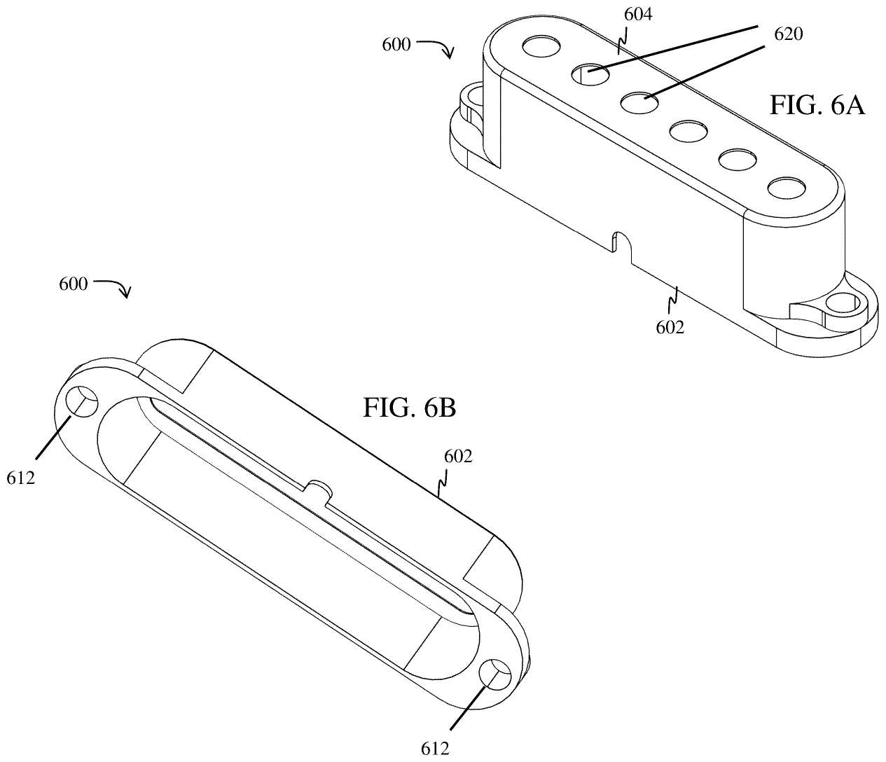

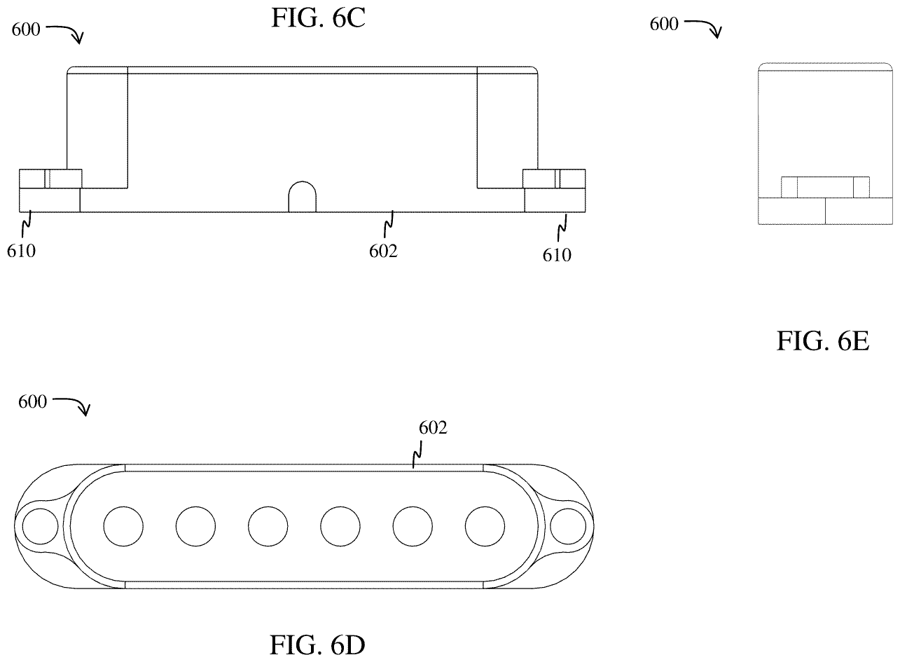

FIGS. 6A-6E depict various views of a third cover 600 of the double coil guitar pickup assembly, according to an example embodiment. FIGS. 6A-6E show how the third cover 600 includes a body 602 that is configured (i.e., shaped and sized) to be securely placed over the joinder 300 of the first and second bobbins 100, 200 double coil guitar pickup assembly 300. The top 604 of the body 602 includes a plurality of orifices 620 that provide access to a top of the joinder 300 of the first and second bobbins 100, 200. The cover 600 includes a pair of flanges 610 on either end of the cover, within which are respectively located a pair of fastening orifices 612 configured for fastening the cover 600 to a guitar. The double coil guitar pickup assembly may comprise the joinder 300 of the first and second bobbins 100, 200, including the coils on the bobbins and at least one of the covers 400, 500, 600.

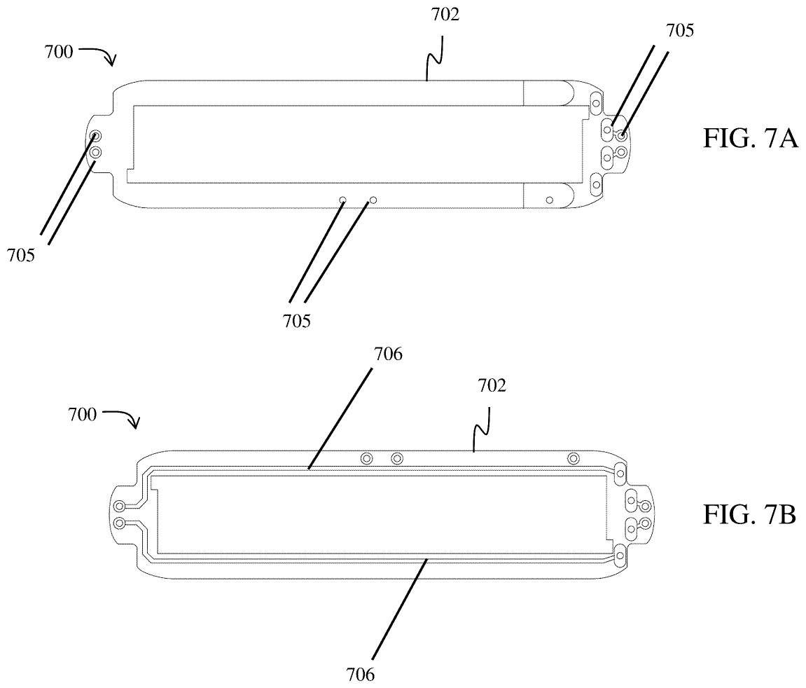

FIGS. 7A and 7B depict top and bottom views of a printed circuit board 700 of the double coil guitar pickup assembly, according to an example embodiment. The printed circuit board is connected to a bottom of the double coil guitar pickup, the printed circuit board including a body 702 configured for coupling with the cover, a plurality of vias 705, and a plurality of traces 706, and wherein the ends of the first and second coils are conductively coupled to respective ones of the plurality of vias.

The PCB 700 is an integral component of the double coil guitar pickup assembly, designed to manage the electrical connections between the various elements of the pickup, ensuring efficient signal transmission and minimal interference. The purpose of the PCB 700 is to create a faster, easier and a more secure way to connect the beginning and end of each coil to the conductor cable that attaches to the electronics portion of the guitar, comprised of switches and potentiometers that go to the output jack of the guitar.

The PCB 700 is strategically positioned at the bottom of the double coil guitar pickup assembly, serving as the foundation for the electrical infrastructure of the pickup. The PCB itself is composed of a non-conductive substrate, typically made from materials such as fiberglass or a composite, which provides structural support for the conductive elements etched onto its surface. The PCB 700 includes a body 702 that is precisely configured to couple with the cover of the assembly, ensuring a secure and stable fit. This coupling is essential for maintaining the alignment of the PCB with the other components of the pickup, thereby preventing any disconnection or misalignment that could degrade performance. Note the body 702 is roughly rectangular in nature and has a void in the middle, such that the body forms a circumferential shape that matches the footprint of the cover.

The board features a plurality of vias 705, which are small, plated-through holes that allow electrical connections to pass between the top and bottom layers of the PCB. These vias are strategically placed to align with the ends of the first and second coils of the pickup. The conductive wire from each coil is threaded through these vias and soldered, establishing a reliable electrical connection that ensures the signals generated by the coils are transmitted with high fidelity. In addition to the vias, the PCB 700 includes a network of conductive traces 706, which are thin pathways of copper or other conductive materials. These traces form the circuit paths that connect the coil terminals to other components on the PCB, or external to the PCB, such as a sound system, depending on the specific design of the pickup assembly. The traces are meticulously designed to minimize resistance and signal loss, ensuring that the electrical signal generated by the coils is preserved as it travels through the circuit.

The PCB also facilitates the integration of additional electronic components that may be part of the pickup assembly, such as tone-shaping circuits, preamps, or other signal processing elements. These components, if present, are mounted directly onto the PCB and are interconnected via the traces. This arrangement not only simplifies the overall assembly process but also reduces the potential for electromagnetic interference (EMI), as the compact and well-organized layout of the PCB helps shield the signal from external noise sources.

Once the coil wires are securely connected to the PCB, the PCB is connected to the conductor cable, which transmits the signal to the guitar's electronic controls, including switches, potentiometers, and ultimately to the output jack. The PCB simplifies this process by providing well-organized traces and terminal points that route the signal from the coils directly to the conductor cable. The PCB includes a network of copper traces that effectively act as the circuit paths. These traces connect the solder points of the coil wires to the terminals where the conductor cable is attached. The layout of these traces is designed to minimize signal loss and interference, ensuring that the electrical signal from the coils is transmitted cleanly and efficiently to the guitar's electronic components.

The conductor cable that is attached to the PCB serves as the link between the pickup assembly and the guitar's electronics, which typically include a series of switches and potentiometers. These components are used by the guitarist to control various aspects of the sound, such as volume, tone, and pickup selection, before the signal is sent to the output jack and then to an amplifier or other external audio equipment. The switches in the guitar's electronic circuit allow the guitarist to select different pickups or coil configurations, such as switching between the neck and bridge pickups or enabling coil-splitting options. The PCB ensures that the signals from the coils are correctly routed through the switches, providing the desired functionality. Potentiometers (often referred to as pots) are used to adjust the volume and tone of the guitar. The PCB's traces and connections are designed to feed the signal from the coils through these potentiometers, allowing the guitarist to modify the sound output to their preference. The final destination of the signal is the guitar's output jack, where it exits the instrument and is sent to an amplifier or other external devices. The PCB ensures that the signal path is clean and uninterrupted from the coils to the output jack, maintaining the integrity of the sound.

In one embodiment, any of the components of the devices 300, 400, 500, 600, 700 described above may be composed of a variety of materials. Said components may be composed of materials such as plastic, metal, and various composites, chosen for their ability to withstand the mechanical stresses and electromagnetic requirements of the device. For the core structure of the first and second body components 100, 200, a high-strength, lightweight plastic such as ABS (Acrylonitrile Butadiene Styrene) or polycarbonate may be used. These materials offer excellent durability and impact resistance, ensuring that the pickup can withstand the rigors of regular use and potential impacts. Additionally, these plastics are easily moldable, allowing for precise manufacturing of the friction-fit mechanism that securely joins the two components together.

The coils themselves may be composed of copper wire, selected for their excellent electrical conductivity and ability to maintain consistent electromagnetic properties. The copper wire is often coated with an insulating material such as enamel to prevent short-circuiting and ensure the integrity of the electrical signal. Subsequently, the pickup with the windings may be dipped in a, insulative material, such as epoxy resin or varnish, to secure the windings in place and provide additional protection against moisture and physical damage.

The magnetic components within the first and second body components may include alnico (aluminum-nickel-cobalt) magnets or ceramic magnets, each offering distinct tonal characteristics. Alnico magnets are prized for their warm, vintage sound and are often used in high-end pickups. In contrast, ceramic magnets provide a more modern, powerful output, suitable for genres requiring a more aggressive tone.

Additionally, the exterior of the first and second components may be coated or encased in a protective material to enhance durability and provide additional shielding against electromagnetic interference. This could include a metal casing or a conductive paint coating, which helps to further reduce noise and hum, ensuring a clean and clear signal.

Embodiments may be described above with reference to functions or acts, which comprise methods. The functions/acts noted above may occur out of the order as shown or described. For example, two functions/acts shown or described in succession may in fact be executed substantially concurrently or the functions/acts may sometimes be executed in the reverse order, depending upon the functionality/acts involved. While certain embodiments have been described, other embodiments may exist. Further, the disclosed methods' functions/acts may be modified in any manner, including by reordering functions/acts and/or inserting or deleting functions/acts, without departing from the spirit of the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A double coil guitar pickup assembly, comprising:
a first bobbin comprising a center section with a hollow interior, a top flange with a diameter greater than a diameter of the center section, and a bottom flange, wherein the top flange has a lateral-facing protrusion and adjacent depression;
a first coil wrapped around the center section of the first bobbin;
a second bobbin comprising a center section with a hollow interior, a top flange with a diameter greater than a diameter of the center section, and a bottom flange, wherein the top flange has a lateral-facing protrusion and adjacent depression;
a second coil wrapped around the center section of the second bobbin;
wherein the first bobbin is coupled with the second bobbin such that the protrusion of the first bobbin fits securely within the depression of the second bobbin, and such that the protrusion of the second bobbin fits securely within the depression of the first bobbin; and
a cover configured to fit securely over the first and second bobbins, including a pair of fastening orifices configured for fastening the cover to a guitar.

2. The double coil guitar pickup assembly of claim 1, wherein the center sections of the first and second bobbins are substantially cuboidal shaped.

3. The double coil guitar pickup assembly of claim 2, wherein the top flanges of the first and second bobbins are substantially shaped as one half of an oval.

4. The double coil guitar pickup assembly of claim 3, wherein the lateral-facing protrusions of the first and second bobbins are substantially cuboidal shaped.

5. The double coil guitar pickup assembly of claim 4, wherein the lateral-facing depressions of the first and second bobbins are substantially cuboidal shaped.

6. The double coil guitar pickup assembly of claim 5, wherein the protrusion of the first bobbin forms a friction-fit with the depression of the second bobbin.

7. The double coil guitar pickup assembly of claim 6, wherein the protrusion of the second bobbin forms a friction-fit with the depression of the first bobbin.

8. The double coil guitar pickup assembly of claim 7, wherein the cover includes an opening that provides access to a top of the first and second bobbins.

9. The double coil guitar pickup assembly of claim 7, wherein the cover includes a plurality of orifices that provide access to a top of the first and second bobbins.

10. The double coil guitar pickup assembly of claim 1, wherein the assembly further comprises a printed circuit board connected to a bottom of the assembly, the printed circuit board including a body configured for coupling with the cover, a plurality of vias, and a plurality of traces, and wherein the ends of the first and second coils are conductively coupled to respective ones of the plurality of vias.

11. A double coil guitar pickup assembly, comprising:
a first bobbin comprising a center section with a hollow interior, a half-oval shaped top flange with a diameter greater than a diameter of the center section, and a bottom flange, wherein the top flange has a lateral-facing protrusion and adjacent depression;
a first coil wrapped around the center section of the first bobbin;
a second bobbin comprising a center section with a hollow interior, a half-oval shaped top flange with a diameter greater than a diameter of the center section, and a bottom flange, wherein the top flange has a lateral-facing protrusion and adjacent depression;
a second coil wrapped around the center section of the second bobbin;
wherein the first bobbin is coupled with the second bobbin such that the protrusion of the first bobbin fits securely within the depression of the second bobbin, and such that the protrusion of the second bobbin fits securely within the depression of the first bobbin; and
a cover configured to fit securely over the first and second bobbins, including a pair of fastening orifices configured for fastening the cover to a guitar.

12. The double coil guitar pickup assembly of claim 11, wherein the center sections of the first and second bobbins are substantially cuboidal shaped.

13. The double coil guitar pickup assembly of claim 12, wherein the top flanges of the first and second bobbins are substantially shaped as one half of an oval.

14. The double coil guitar pickup assembly of claim 13, wherein the lateral-facing protrusions of the first and second bobbins are substantially cuboidal shaped.

15. The double coil guitar pickup assembly of claim 14, wherein the lateral-facing depressions of the first and second bobbins are substantially cuboidal shaped.

16. The double coil guitar pickup assembly of claim 15, wherein the protrusion of the first bobbin forms a friction-fit with the depression of the second bobbin.

17. The double coil guitar pickup assembly of claim 16, wherein the protrusion of the second bobbin forms a friction-fit with the depression of the first bobbin.

18. The double coil guitar pickup assembly of claim 17, wherein the cover includes an opening that provides access to a top of the first and second bobbins.

19. The double coil guitar pickup assembly of claim 17, wherein the cover includes a plurality of orifices that provide access to a top of the first and second bobbins.

20. The double coil guitar pickup assembly of claim 11, wherein the assembly further comprises a printed circuit board connected to a bottom of the assembly, the printed circuit board including a body configured for coupling with the cover, a plurality of vias, and a plurality of traces, and wherein the ends of the first and second coils are conductively coupled to respective ones of the plurality of vias.
